(19) United States
(12) Patent Application Publication
(10) Pub. No.: US 2004/0263115 A1
(43) Pub. Date: Dec. 30, 2004

(54) Charging unit for use with wheeled sports equipment

(76) Inventor: Robert T. Bailey III, Lakewood, NJ (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/603,580

(22) Filed: Jun. 25, 2003

(51) Int. Cl. H02J 7/00

(52) U.S. Cl. 320/104

(57) ABSTRACT

A generator and battery charging unit is operable on a wheeled apparatus, including rollerblades and skateboards. The charging unit is operable while the wheeled apparatus is used to provide fresh power to a rechargeable battery. A charging base holds one or more batteries for charging. The charging base receives electric current produced by a generator powered by motion of the wheels. For this purpose, a stepper motor is mounted to the wheeled apparatus and connected to the charging base. The stepper motor has a shaft that communicates with a wheel on the apparatus. The shaft is rotatable with the wheel to power the stepper motor and generate electric current. The electric current is passed to the charging base to charge one or more batteries in the charging base. In addition to the charger, the stepper motor may be connected to an output jack or an accessory to be operated by current from the stepper motor.

### FIELD OF THE INVENTION

The present invention relates to electrical devices powered by small generators, and particularly to a generator and battery charging unit mounted on wheeled sports equipment.

### BACKGROUND

In-line skates (rollerblades), skateboards, scooters and other wheeled apparatuses provide means for exercise, amusement, recreation and transportation. These apparatuses are often used in conjunction with battery-powered accessories, including portable radios, portable compact disk players and helmet lights. Exercise enthusiasts, for example, use battery-powered headset radios to play music while they exercise on rollerblades. For many individuals, music physically motivates the individual and increases the enjoyment of exercise. The enjoyment of exercise can quickly diminish if the battery charge that powers the headset radio or other music playing device drains before the workout is complete. Therefore, it is desirable to have a reliable source of power for accessories used in conjunction with exercise and recreational equipment.

### SUMMARY OF THE INVENTION

Based on the foregoing, the present invention includes a battery charging unit for use on a variety of wheeled sports equipment and apparatuses, including but not limited to rollerblades, bicycles, skateboards and scooters. The charging unit operates while the wheeled sports equipment is in use to provide fresh battery power at almost any time when battery power is needed. The charging unit has a charging base that holds one or more rechargeable batteries for charging while the sports equipment is used. The charging base receives electric current from a generator mounted to the sports equipment. In one embodiment of the invention, a stepper motor is mounted to the sports equipment and connected to the charging base. The stepper motor has a shaft that couples with a wheel on the sports equipment. The shaft is rotatable with the wheel to rotate the shaft of the stepper motor and generate pulses of electric current. The electric current is passed to the charging base to charge one or more rechargeable batteries in the charging base. The stepper motor may have multiple windings that generate current pulses in multiple phases. For instance, the stepper motor may have a first phase winding that passes current to the charging base, and a second phase winding. The second phase winding may be connected to a separate component mounted to the sports equipment, such as a lighting element, or to an output jack that connects with a portable radio or other accessory. An optional engagement lever may be included to move the shaft into and out of communication with the wheel that drives the shaft, allowing the user to enable or disable the stepper motor while the sports equipment is used.

### DESCRIPTION OF THE DRAWINGS

The foregoing summary as well as the following description will be better understood when read in conjunction with the figures in which:

FIG. 1 is a block diagram of an apparatus in accordance with the present invention.

FIG. 2 is a perspective view of the apparatus of FIG. 1 installed on an in-line skate.

### DETAILED DESCRIPTION OF THE PREFERRED EMBODIMENT

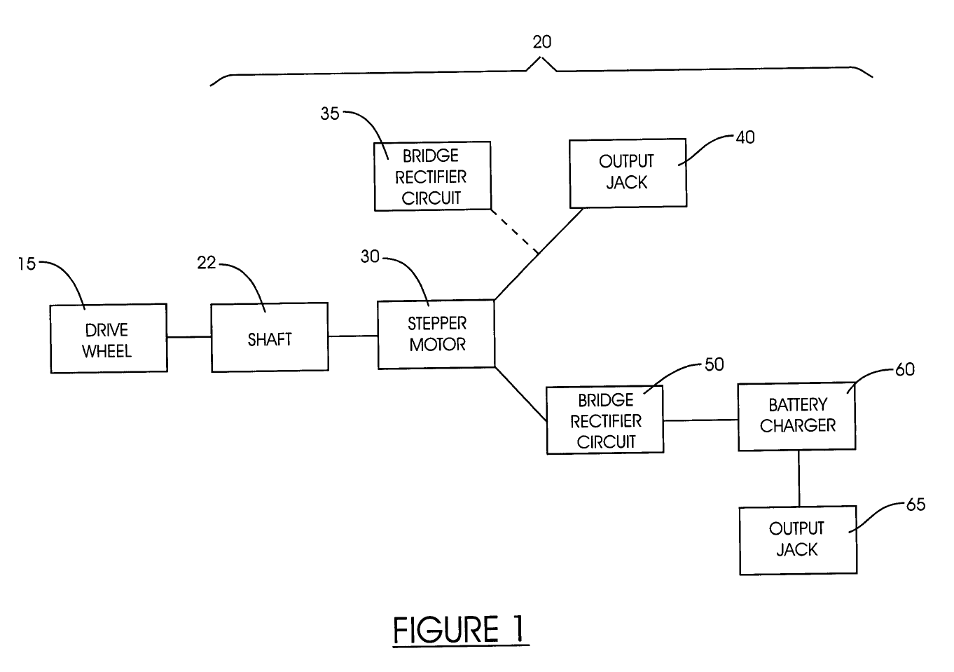

Referring to the drawing figures in general, and to FIG. 1 specifically, a generator and charging apparatus 20 is shown schematically in a block diagram. The apparatus 20 is mountable to wheeled equipment and includes a small stepper motor 30, or other suitable electrical generator, that produces electrical current when the wheels of the equipment are rotated, for example, when the wheeled equipment rolls on a surface. The stepper motor 30 includes a shaft 22 that rotates to produce electric current. The shaft 22 is driven by a wheel 15 on the equipment that cooperates with the shaft. As the wheeled apparatus rolls on a surface, the drive wheel 15 rotates and transfers torque through the shaft 22 to the stepper motor 30.

The shaft 22 may be mounted in a variety of positions to cooperate with the drive wheel 15. For example, the shaft 22 may be mounted in proximity to the drive wheel 15 so that the circumference of the drive wheel frictionally engages the shaft or a roller on the shaft. As the wheel 15 spins or rotates, the frictional engagement between the wheel and the shaft 22 causes the shaft to rotate. As an alternative, the drive wheel may be coupled to the shaft 22 through a suitable belt arrangement or a suitable gear arrangement. The rotating shaft 22 transfers torque to the stepper motor 30 to generate electric current.

The stepper motor 30 may be a two phase motor having a first phase winding and a second phase winding. Stepper motors with different phases and windings may also be used. The stepper motor 30 has a stator and a rotor that rotates relative to the stator. The rotor is connected to the shaft 22 and rotates in response to torque transferred from the shaft. As the rotor rotates relative to the stator, the first and second phase windings are energized to produce pulses of current in two phases. The first phase winding may be connected to a charger 60 operable to charge one or more rechargeable batteries. The charger circuit may also include an output jack 65 to supply power from the batteries or from the stepper motor, or from a combination of both, to suitable accessories. The second phase winding may be connected to one or more devices or outputs, as desired. In FIG. 1, the second phase winding is connected to an output jack 40. The second winding of the stepper motor 30 may be connected directly to the output jack 40 to supply AC power to the jack or the secondary winding may be connected through a rectifier bridge 35 to the output jack 40 to supply DC power to the jack.

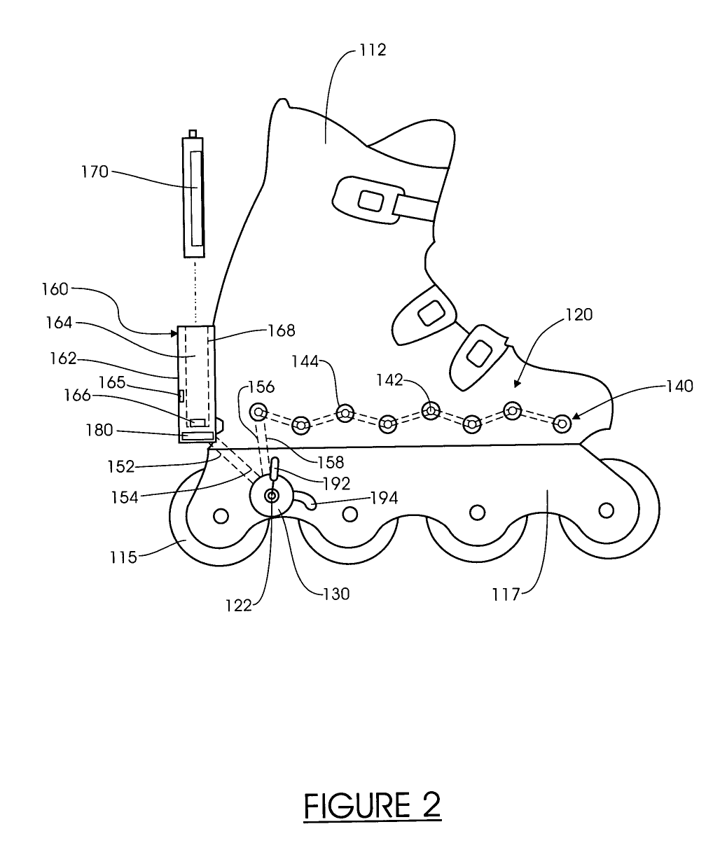

Referring now to FIG. 2, a charging/lighting apparatus 120 is mounted to an in-line skate 110. The in-line skate 110 has a boot 112 and four skate wheels 115 mounted to a frame 117 beneath the boot. The charging/lighting apparatus 120 has a stepper motor 130, used as an electrical generator, mounted near the base of the boot 112, with a shaft 122 in frictional communication with the circumference of rear wheel 115 on the skate. A suitable friction roller may be mounted on the shaft 122 to engage the wheel 115. Other wheels of the skate could also be used to power the stepper motor. The stepper motor 130 has a first phase winding connected to a battery charger 160 by a pair of charging wires 152, 154. The battery charger 160, which may be mounted in a variety of locations on the boot 112, is operable to charge one or more rechargeable batteries 170 to be used, for example, in a portable headset radio, helmet light, or other battery powered accessory. In FIG. 2, the battery charger 160 is connected to the heel portion of the boot 112. The battery charger 160 comprises a charging base 162 that forms a receptacle 164 for storing and charging one or more rechargeable batteries 170. The receptacle 164 contains charging terminals 166 connected to wires via 152, 154. Recesses 168 in the receptacle 164 are configured to receive the rechargeable batteries 170 and align the batteries so that the charging terminals 166 in the receptacle mate with charging contacts on the batteries. Each recess 168 conforms to the shape of a rechargeable battery to snugly hold the battery and maintain the battery contacts securely against the charging terminals 166.

The charging wires 152, 154 connect with a bridge rectifier circuit 180 which is wired between the first phase winding and the charging terminals 166. The rectifier circuit 180 may be enclosed within the charging base 162. The rectifier circuit 180 is configured to convert AC current from the stepper motor 130 to a pulsating DC current. A suitable smoothing compactor and/or a regulator may also be included to smooth or regulate the DC output. The DC current passes from the rectifier 180 to the terminals 166 to charge one or more batteries in the charging base 122. The battery charger 160 may have one or more output terminals 165 mounted on the base 162 connected with the rechargeable batteries housed in the base and/or with the rectifier circuit 180 to provide a source of DC power for accessories.

The second phase winding on the stepper motor 130 may be connected to a lighting element 140 connected on the side of boot 112. The light element may be connected to the second winding of the stepper motor through a suitable rectifier circuit (such as rectifier circuit 135) to power a DC output. The lighting element 140 illuminates to create a visual effect when the rear wheel of the skater is in motion. The second phase winding is connected to the lighting element 140 by a pair of lighting wires 156, 158. Lighting wires 156, 158 are configured to carry pulses of current between the second phase winding and the lighting element 140 when the second phase winding is energized. A rectifier careered, such as rectifier circuit 35 shown in FIG. 1, may be connected between the stepper motor 130 and the lighting element 140 along wires 156 and 158 so that DC power is supplied to the lighting element 140. The lighting element 140 is powered by torque generated by wheel 115 when the skate 110 is in motion.

The lighting element 140 includes one or more LEDs 142 arranged in a decorative pattern on the side of the boot 112. The LEDs 142 are connected to the second phase winding in a parallel circuit. Each LED 142 may be covered by a transparent or translucent cover 44 to protect the components and connections in the lighting element 140. The lighting wires 156, 158 may be secured along the exterior of the boot 112, or on the inside the boot to substantially conceal the wires. In FIG. 2, dashed lines represent sections of lighting wires 156, 158 that are arranged on the inside of the boot 112. The wires 156, 158 connect with the LEDs 142 through small holes that are cut or punched through the side of the boot 112 in proximity to each LED.

The apparatus 120 has an optional engagement lever 190 that can be used to enable or disable stepper motor 130 when the skate 110 is in use. In this way, the lighting element 140 and charger 160 can be disabled while the skate 110 is used, without having to remove the apparatus 120 from the skate. The engagement lever 190 includes a lever arm 192 that is displaceable to pivot the stepper motor 130 and move the shaft 122 into and out of communication with the drive wheel 115. The engagement lever arm 192 is displaceable between an engaged position, which retains the shaft 122 in frictional communication with the drive wheel 115, and a disengaged position, which retains the shaft in a position out of communication with the drive wheel. The stepper motor 130 and shaft 122 pivot through an arc-shaped path between the engaged position and disengaged position. The shaft 122 extends through an arc-shaped slot 194 in the frame 117. The slot 194 permits the shaft to pivot between the engaged and disengaged positions. A variety of components may be used to form the engagement lever 190, such as a spring-biased latch with releasable detent, or a ratcheting arm with a releasable pawl.

The operation of the apparatus 120 will now be described as used on the in-line skate 110. The engagement lever arm 192 is moved to the engaged position to enable the shaft 122 to transfer power to the stepper motor 130 and operate the lighting element 140 and charger 160. The skate glides or rolls over a surface, spinning the rear wheel 115 on the skate. As the rear wheel 115 rotates, the frictional communication between the shaft 122 and rear wheel causes the shaft to rotate. The rotating shaft 122 transfers torque to the rotor in the stepper motor 130, which energizes the first and second phase windings. Current from the first phase winding is passed to the charger 160 in a first phase. The rectifier circuit 180 receives the current pulses from the first phase winding and converts the AC current to DC current. The DC current is passed to the charger terminals 166 to charge batteries 170 in the charger base 162. Current from the second phase winding is passed to the lighting element 140. The current pulses alternate the polarity and periodically exceed the threshold voltage of the LEDs 142 in the lighting element 140. Even if a rectifier is used, the DC current pulses may cycle above and below the threshold voltage of the LEDs 142. When the applied voltage exceeds the applicable threshold, the LEDs 142 are illuminated.

The terms and expressions which have been employed are used as terms of description and not of limitation. There is no intention in the use of such terms and expressions of excluding any equivalents of the features shown and described or any portions thereof. It is recognized, therefore, that various modifications are possible within the scope and spirit of the invention. Accordingly, the invention incorporates variations that fall within the scope of the following claims.

I claim:

1. A generator and battery charging unit for use on a wheeled apparatus, comprising:
A. a generator having a rotor and a stator, said generator comprising at least a first phase winding;
B. a rotatable shaft extending from the rotor in communication with a wheel on the apparatus; and
C. a charging base for holding a rechargeable battery, said charging base being electrically connected with said first phase winding,
wherein, upon rotation of the wheel on the wheeled apparatus, the wheel is operable to transfer torque to the shaft in communication with the wheel, said shaft being rotatable with the rotor relative to the stator to produce a first winding current in the first phase winding, said first winding current being operable to charge the rechargeable battery in the charging base.

2. The generator and battery charging unit of claim 1, wherein the charging base comprises a receptacle adapted to receive one or more of the rechargeable batteries.

3. The battery and charging unit of claim 2 comprising a rectifier connected with the receptacle and the generator to supply DC power to the receptacle.

4. The generator and battery charging unit of claim 1 comprising an electrical terminal in communication with the receptacle for supplying electrical power to an accessory.

5. The battery and charging unit of claim 4 comprising a rectifier connected with the electrical terminal to supply DC power to the electrical terminal.

6. The generator and battery charging unit of claim 1, wherein the generator comprises a second phase winding operable to produce a second winding current.

7. The generator and battery charging unit of claim 6, wherein at least one of the first and second phase windings is electrically connected with an output jack.

8. The generator and battery charging unit of claim 6, wherein the second phase winding is electrically connected with a lighting element.

9. The generator and battery charging unit of claim 8, wherein the lighting element comprises a plurality of LEDs configured for mounting on the wheeled apparatus.

10. The generator and battery unit of claim 1 wherein the generator comprises a stepper motor.

11. A skate having a boot and a plurality of wheels arranged on the boot for rolling on a surface, said skate comprising:
A. a stepper motor having a rotor and a stator, said stepper motor comprising at least a first phase winding;
B. a rotatable shaft extending from the rotor in communication with a wheel on the skate; and
C. a charging base electrically connected to said first phase winding, said charging base forming a receptacle adapted to receive a rechargeable battery,
wherein, as the skate rolls along a surface, the wheel rotates to transfer torque to the shaft, said shaft being rotatable with the rotor relative to the stator to produce a first winding current in the first phase winding that passes to the charging base to charge the battery in the receptacle.

12. The skate of claim 11, wherein the stepper motor comprises a second phase winding operable to produce a second winding current.

13. The skate of claim 12, wherein at least one of the first and second phase windings is electrically connected with an output jack.

14. The skate of claim 12, wherein the second phase winding is electrically connected with a lighting element.

15. The skate of claim 14, wherein the lighting element comprises a plurality of LEDs secured to the exterior of the boot.

16. The skate of claim 11, comprising an engagement lever operably connected to and displaceable with the shaft, said lever being movable to an engaged position in which the shaft communicates with the wheel, and a disengaged position in which the shaft is positioned out of communication with the wheel.

17. The skate of claim 16, wherein said lever is moveable to the engaged position to move the shaft into frictional engagement with the wheel and is moveable to the disengaged position to move the shaft out of frictional engagement with the wheel.

18. The skate of claim 11, wherein the charging base comprises a receptacle adapted to receive one or more of the rechargeable batteries.

19. The skate of claim 18, wherein the generator comprising a rectifier connected with the receptacle and the stepper motor to supply DC power to the receptacle.

20. The skate of claim 11, comprising an electrical terminal in communication with the receptacle for supplying electrical power to an accessory.

21. The skate of claim 20, comprising a rectifier connected with the electrical terminal to supply DC power to the electrical terminal.
